(19) United States
(12) Patent Application Publication
(10) Pub. No.: US 2006/0129828 A1
(43) Pub. Date: Jun. 15, 2006

(54) Method which is able to centralize the administration of the user registered information across networks

(76) Inventor: Xuanming Shi, Taiwan (CN)

Correspondence Address: Supreme Patent Services, PO Box 2339, Saratoga, CA, 95070-0339, US

(21) Appl. No.: 10/523,652

(22) PCT Filed: Aug. 22, 2002
(86) PCT No.: PCT/CN02/00581

§ 371 Date: Feb. 4, 2005

(30) Foreign Application Priority Data
Aug. 5, 2002 (CN) 02125941.0

(51) Int. Cl. H04L 9/00

(52) U.S. Cl. 713/182

(57) ABSTRACT

A method for centralizing administration of user registration information across networks is provided. It includes at least an Internet Content Provider (ICP) and a user-login-identification means, which can access an online terminal. The ICP adds an interface module in a login web page and accesses the user-login-identification means via the interface module. In addition, the ICP provides an administration/drive module monitoring access of the user-login-identification means to set up a connection and hang up the connection for the user-login-identification means in the login web page. The user-login-identification means has an ID number, and user's login identification information is stored in the user-login-identification means. According to the method and system of the present invention, the user is quickly and conveniently provided with a safe and universal login mode, in the case that the Internet Content Provider (ICP) makes no modification or only simple medications to the web page. The user not only can log in networks by using the login identification means which is safe and flexible but also can move conveniently at any time.

### TECHNICAL FIELD

The present invention relates to a method and a system for identifying and administrating user registration information in networks, and more particularly, to a method and a system for centralizing administration of the user registration information across networks. The invention belongs to the computer technical field.

### BACKGROUND OF THE INVENTION

Network is increasingly involved in people's daily life. Using a network to exchange and transmit information is becoming a more and more important information alternating communication method. In an actual operation, a user has to enter his username and password when logging in a website. The network will only provide the user with particular services after the user is identified. These operations become very bothering when the user has registered on a plurality of websites.

Microsoft has provided a network passport identification service, which allows the user using one username and one password to access appendant websites of Microsoft.com and increasing number of participant websites.

Microsoft Passport is a kind of mono-service, which allows the user using only one username and one password to access appendent websites of Microsoft.com and increasing number of participant websites. Owning a Passport means that you only need to remember one username and one password, and the technique is very easy. Because there is only one username and password to remember, you need only one click operation to log in other websites after you have logged in a participant website, and it is very fast. A user can store his information in the passport login profile, therefore he will not have to enter his personal information once more while accessing other participant websites, which is safer. The user's personal information is protected by a powerful encryption technology and rigid privacy security measures, and the user can always control which website is able to access his personal information including his e-mail and mail addresses. Furthermore, when the user logs out, all the information related to his passport will be deleted from the computer, so it is safe to use his personal information on public or shared computers.

Once having a .NET passport, the user can access each new website without registering username and password —as long as he has logged in any one of the participant websites or services by using his email address and password which were adopted in registering the .NET Passport. When the user enters his username and password in the login box to log in a .NET passport participant website, the .NET Passport will verify the following information:

Whether the entered username has been registered as .NET Passport; whether the entered password is correct. If the result is positive, the NET Passport service will inform the website about the user ID (in the case that valid login certification has been provided), and then the user will be permitted to access the participant website. Once having logged in a participant website of the .NET Passport during an Internet session, the user can log in other participant websites by a single click on the “.NET Passport login” button in each participant website.

The user's operation comprises the following steps:

1. Register the username and password of the .NET Passport (the username is an Email address);

2. Log in any of the participant websites or services;

3. Enter the username and password in the login box of the .NET Passport;

4. The access to the participant website is permitted (login succeeds) if the username is registered as .NET Passport and the entered password is correct;

5. During the Internet session, it is not necessary to enter the password again when the user logs in other participant websites or services.

Although owning a Passport means that the user only needs to remember one username and password, it is hard to modify all the data formats uniform and the number of websites participating in the Passport is limited due to the difference of existing data formats of different websites. The Windows provides a function for remembering usernames and passwords, but it only fits for some personal computers since the function only exists in local computers which results in less security and portability.

### SUMMARY OF THE INVENTION

The object of the invention is to provide a system and a method for centralizing administration of user registration information across networks, and to quickly and conveniently provide a safe and universal login mode, in the case that the Internet Content Provider (ICP) makes no modification or only simple medications to the web page.

Another object of the invention is to provide a system and a method for centralizing administration of user registration information across networks. The user can log in networks conveniently by using the system which is safe, flexible and can be moved at any time.

The objects of the invention are achieved as follows:

A method for centralizing administration of user registration information across networks, including at least an Internet Content Provider (ICP) and a user-login-identification means which can access an online terminal; wherein, the ICP adds an interface module in a login web page and accesses the user-login-identification means via the interface module, and the ICP also provides an administration/drive module monitoring access of the user-login-identification means to set up a connection and hang up the connection for the user-login-identification means in the login web page; the user-login-identification means is provided with an ID number, and the user's login identification information is stored in the user-login-identification means.

Authenticating the ICP includes the steps of, obtaining an authentication file, transmitting the authentication file to the administration/drive module, decrypting the authentication file by the administration/drive module, and accessing the user-login-identification means.

The administration/drive module can lead in and/or lead out the data stored in the user-login-identification means so as to backup the data. The administration/drive module can also automatically log in the network after the ICP has accessed user-login-identification means via the interface module and verified the identification information.

Furthermore, the authentication between the ICP and the login verification serving party can also be achieved in online mode according to the invention. The ICP accesses the login verification serving party, and the login verification serving party transmits a code of the user-login-identification means to the ICP which adds the login identification information in the login web page according to the code. The interface module transmits the ICP information to the login verification serving party for verification, and the access to the user-login-identification means is permitted in the case of valid verification. The Login verification serving party maintains a database of authentication files so as to manage the authentication files.

The login verification serving party and/or the ICP website provide an interface module and an administration/drive module, and verify whether the interface module and the administration/drive module have been downloaded. If positive, the modules are activated; if negative, the modules are downloaded firstly, and then activated. In the case that the user-login-identification means is in an active state, the ICP can access the user-login-identification means only after it has been authenticated by the login verification serving party.

Particularly, accessing the user-login-identification means includes storing or reading login identification information in the user-login-identification means. The login verification serving party transmits an authentication file to the ICP, and the ICP accesses the user-login-identification means according to the file. The authentication file includes ICP identification information, and/or specific area guide information of the user-login-identification means and/or data processing guide information.

Furthermore, a registration table of the ICP identification information is stored in the user-login-identification means, and is used for guiding different ICPs to access the corresponding areas or contents while accessing the user-login-identification means. The administration/drive module can lead in and/or lead out the data stored in the user-login-identification means so as to backup the data, and can also automatically log in the network after the ICP has accessed the user-login-identification means via the interface module and verified the identification information.

Furthermore, the ICP reads out the information stored in the user-login-identification means via the interface module. If login identification information is obtained, the interface module returns the login identification information to the ICP web page and determines whether an automatic submit and login should be performed according to the user's setup; if the login identification information is not obtained, the interface module informs the web page that login identification information is not available and stores the generated login identification information in the user-login-identification means.

Storing the login identification information includes the ICP storing the login identification information in the user-login-identification means via the interface module, in the case that the user logs in the ICP website for the first time, or the user selects to manually enter the login information once more, or the user-login-identification means is used for the first time.

The ICP web page is provided with a registration information window; the ICP invokes parameters of the interface module and saves several sets of registration information of the same web page or the last set of registration information.

For example, The ICP web page is provided with a registration information window. The ICP accesses the user-login-identification means via the interface module and verifies the login identification information provided by the ICP web page, and stores the new login identification information in the user-login-identification means to overwrite the original login identification information, and then transfers the relating information to the ICP web page. The information is displayed on the web page after being obtained.

Moreover, the ICP web page is provided with a plurality of window links to the registration information. The ICP reads the user-login-identification information stored in the user-login-identification means and verifies the login identification information provided by the ICP web page; if negative, the ICP stores the login identification information in the user-login-identification means, if positive, the ICP directly reads it out and transfers the relating information to the ICP web page. The information is displayed on the web page after being obtained.

Particularly, the user login identification information includes the ICP identification information or the form information or the user identification information or the combination of the above.

A system for realizing any one of the said methods comprises a computer, Internet networks, an ICP and a user-login-identification means, wherein the computer can log in the internet network to communicate with different ICPs; the user-login-identification means is capable of accessing the computer from outside and has at least an identification number and encryption storage space. The user-login-identification means performs the information transmission by operating the computer.

The information transmission between the computer and the user-login-identification means is processed with encryption or decryption. The encryption includes protecting an encryption area by using the user's PIN code or encryption utilizing RSA 512PKI key management. The user-login-identification means is also provided with a storage region for storing the information of the ICP itself.

Particularly, the user-login-identification means can be an external and portable memory means with a standard data interface, or a card-reader means or an ID identifying means thereof, for example, a USB storage device, a CF card, a MMC card, a SD card, a SMC card, an IBM Micro Drive card, a flash storage module or an IC card, or the corresponding card reader therein.

Moreover, the user-login-identification means can be a computer peripheral, such as a keyboard, a mouse, a handwriting board, sound boxes, or a portable PDA, a music player, or an electrical dictionary.

Furthermore, the ICP of the system of this invention is connected with a login verification serving party, which transmits the code of the user-login-identification means to the ICP, and the ICP adds the login identification information on the web page according to the code. The interface module transmits the ICP information to the login verification serving party to verify the information, and the access to the user-login-identification means is permitted if the verification is valid. In particular, the login verification serving party is a server.

According to analyzing the above technical solution, it is obvious that the invention has the following advantages:

1. The registration information is centralized so that the bothering operations of logging in networks are simplified.

2. The portable hardware can be carried by the user, and can be used at any time or any place.

3. The security of the user's personal information is guaranteed by the double encryption of both hardware and data.

4. The user's operation is visual and simple because of the practical function management provided by the administration/drive module.

5. The ICP doesn't need to modify the existing data format.

6. The ICP obtains a flexible interface, which can be extended with many customized applications besides the login application.

### BRIEF DESCRIPTION OF THE DRAWINGS

FIG. 1 is a schematic network system according to the invention;

FIG. 2 is a flowchart illustrating the user accessing the ICP to download the administration/drive module according to the invention;

FIG. 3 is a flowchart illustrating the ICP accessing the user-login-identification means according to the invention;

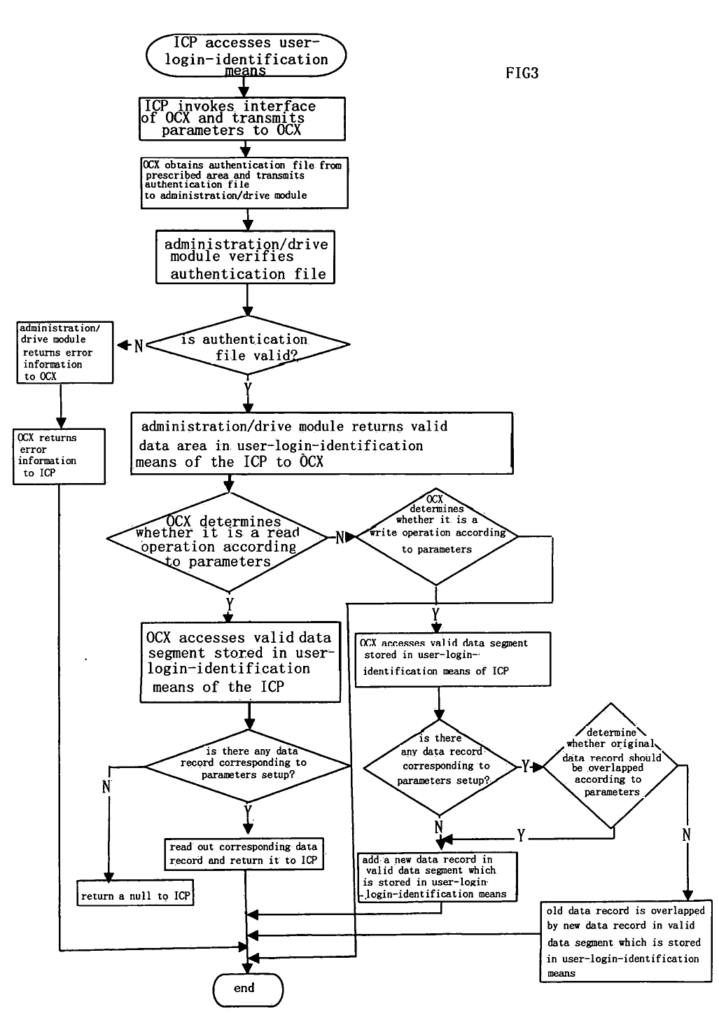

FIG. 4 is a flowchart illustrating the user logging in the ICP by utilizing the login identification means according to the invention.

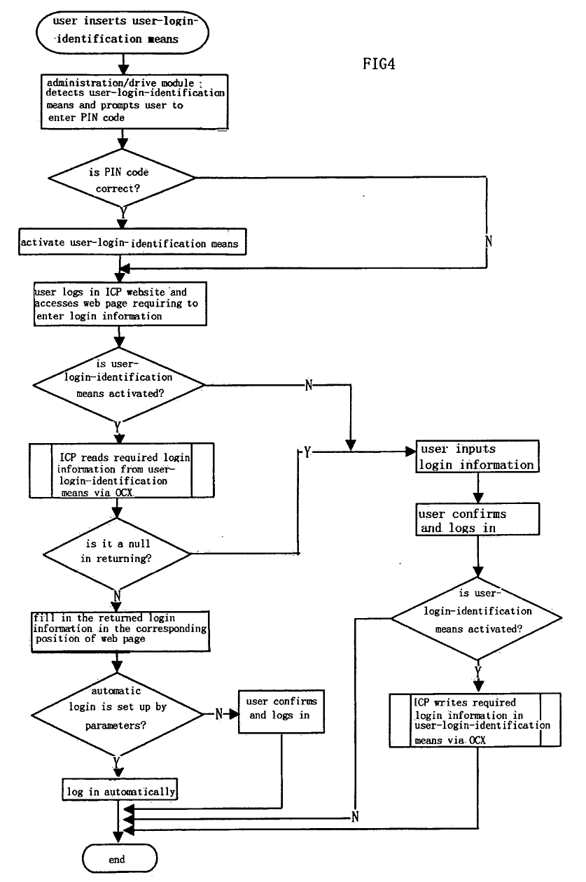

### DETAILED DESCRIPTION OF THE EMBODIMENTS

Next, the invention will be described in details in conjunction with the figures and the specific embodiments.

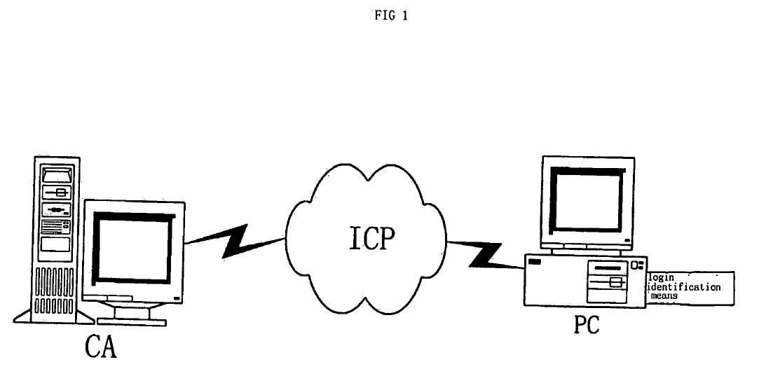

As shown in FIG. 1, the present invention comprises a computer, Internet networks, an ICP and a user-login-identification means. The computer can log in the Internet network to communicate with different ICPs; the user-login-identification means is a device which can connect with the computer from outside and has at least an identification number and encryption storage space, and performs the information transmission by operating the computer. Particularly the ICP adds an interface module in the login web page and accesses the user-login-identification means via the interface module. The ICP also provides an administration/drive module monitoring access of the user-login-identification means to set up a connection and hang up the connection for the user-login-identification means in the login web page; the user-login-identification means is provided with an ID number, and the user's login identification information is stored in the user-login-identification means.

Particularly, the user-login-identification means can be an external and portable memory means with a standard data interface, or a card-reader means or an ID identifying means thereof, for example, a USB storage device, a CF card, a MMC card, a SD card, a SMC card, an IBM Micro Drive card, a flash storage module or an IC card, or the corresponding card reader therein.

Moreover, the user-login-identification means can be a computer peripheral, such as a keyboard, a mouse, a handwriting board, sound boxes, a portable PDA, a music player, or an electrical dictionary.

Wherein the user-login-identification means can have a unique identification number, or a plurality of identification numbers for the use of various people by partitioned control.

The method and system according to present invention provide a universal network ID, which can be identified uniquely. By utilizing the login-identification means, any user can automatically log in all the authorized ICPs or the ICPs with the right to access the login-identification means.

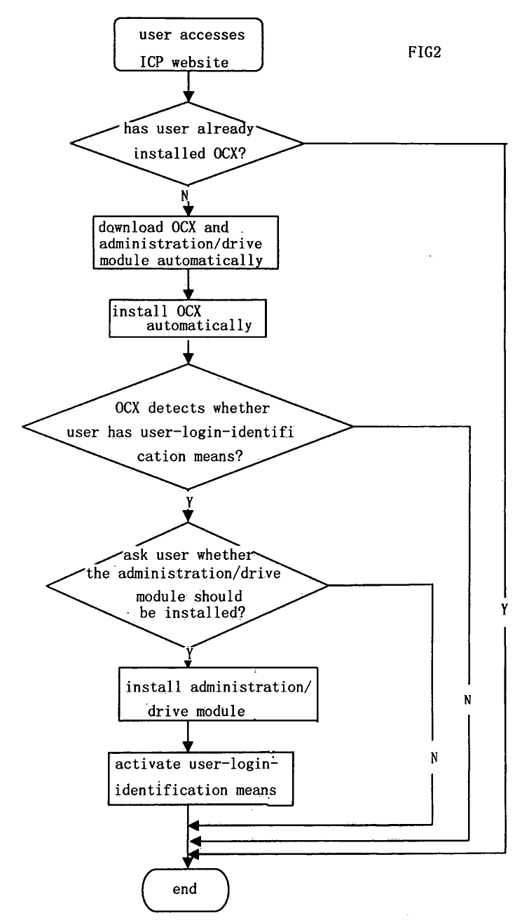

The login verification serving party such as CA can proceed online authorization and authentication with the ICP and the user-login-identification means; authentication between the ICP and the user-login-identification means can be self accomplished offline—without the login verification serving party participating in, and according to the information stored in the user-login-identification means.

Wherein, the procedure of the authentication and login between the ICP and the user-login-identification means will be described in combination with the FIG. 2, 3. It comprises at least an Internet Content Provider (ICP) and a user-login-identification means which can access an online terminal; wherein the ICP adds an interface module in a login web page, and accesses the user-login-identification means via the interface module. The ICP also provides an administration/drive module monitoring access of the user-login-identification means to set up a connection and hang up the connection for the user-login-identification means in the login web page; the user-login-identification means has a unique ID number, and is utilized in storing the user's login identification information. The administration/drive module can lead in and/or lead out data stored in the user-login-identification means so as to backup the data. The administration/drive module can also automatically log in the network after the ICP has accessed the user-login-identification means via the interface module and verified the identification information.

The steps are as follows:

1. Inserting the user-login-identification means and downloading the administration/drive module;

2. Entering the PIN code, activating the user-login-identification means and logging in the web page requiring to enter the login information; the ICP access authentication information is stored in the user-login-identification means to verify whether the accessing ICP has been authorized to access it. The authentication file includes the ICP identification information and/or the specific area guide information of the user-login-identification means and/or data processing guide information and/or time information. The registration table of the ICP identification information is stored in the user-login-identification means, to guide different ICPs only accessing the corresponding areas or contents in the means. Different ICPs store or read the respective login-identification information in the corresponding areas of the user-login-identification means.

3. The ICP accesses the user-login-identification means and proceeds authentication; if the verification is valid, the access is permitted; otherwise, the access is not permitted. Wherein the accessing comprises checking the user ID identification information stored in the user-login-identification means or generating the user ID identification information in the user-login-identification means. Particularly, the ICP authentication comprises obtaining the authentication file via the interface module, transmitting the file to the administration/drive module, decrypting the authentication file by the administration/drive module, and accessing the user-login-identification means.

4. The ICP reads the information stored in the user-login-identification means, and if the login identification information is obtained, the interface module returns the login identification information to the ICP web page and determines whether a login-submit or an automatic submit & login should be performed according to the user's setup; if the login identification information is not available, the interface module informs the web page that login identification information is not available, and stores the generated login identification information in the user-login-identification means. Storing the login identification information includes the user logging in the ICP website for the first time, or the user selecting to manually enter the login information once more, or the first time use of the user-login-identification means, and the ICP stores the login identification information in the user-login-identification means via the interface module.

If the ICP web page is provided with a registration information window, the ICP invokes the parameters of the interface module and saves several sets of registration information of the same web page or the last set of registration information in the user-login-identification means, which can be displayed in the ICP web page. In particular:

The ICP web page is provided with a registration information window. The ICP accesses the user-login-identification means via the interface module, and verifies the login identification information provided by the ICP web page, and stores the new login identification information data in the user-login-identification means to overwrite the original login identification information, and then transfers the relating information to the ICP web page. The information is displayed in the web page after being obtained.

The ICP web page is provided with a plurality of window links of the registration information. The ICP reads the user-login-identification information stored in the user-login-identification means, and verifies the login identification information provided by the ICP web page, stores the login identification information in the user-login-identification means in the case of negative verification, or directly reads and transfers the relating information to the ICP web page in the case of positive verification. The information is displayed in the web page after being obtained.

Another embodiment of the invention provides a method and a system for authorizing and authenticating online among the login verification serving party, the ICP and the user-login-identification means to log in the network. The method comprises the following steps:

According to the invention, the administration/drive module is added by the ICP according to the authorization of the login verification serving party. The authorized ICP stores and reads out the user login information via the interface of the interface module (e.g. OCX). According to this solution, the ICP only need to make simple modifications to the web page. The user uses a user-login-identification means with an encryption storage space of over 1M Bytes to store the user's login information. The data stored in the encryption storage space can be accessed by API. The user can activate the user-login-identification means of the administration/drive module by using the PIN code.

The login verification serving party provides an encrypted authentication file for each ICP to authorize and authenticate the authorization. Because different ICPs have different authentication files, each ICP could only access its own data and has no right to access the data of other ICP; an OCX is provided, and the ICP adds the OCX in its own web page so as to store and read out the relating information in the corresponding area of the user-login-identification means by invoking the Interface of the OCX. The OCX is also responsible for transmitting the ICP authentication files to the server of the login verification serving party for verification.

The server terminal of the login verification serving party is used for verifying the ID of each ICP.

The user-login-identification means of the administration/drive module is based on the USB interface, and is provided with an encryption storage space of over 1M (which can be accessed via the API). There are two methods which can perform encryption. Simple encryption: protecting an encryption area by using only the user PIN code, and if the code is correct, the data stored in the encryption storage space can be accessed; PKI encryption: including RSA 512 PKI key management, data stream encryption, and multi-key authorization management.

Wherein the administration/drive module is realized as follows:

After the administration/drive module is installed, a corresponding Tray Icon will be added on the user's desktop; and the user can activate or close the administration/drive module. The user has to enter the password to activate the administration/drive module; the administration/drive module monitors the port of the user-login-identification means, when the user inserts the user-login-identification means of the administration/drive module, the user is asked to enter the password to activate the user-login-identification means of the administration/drive module. If the user cancels the operation or the entered password is not correct, the user-login-identification means of the administration/drive module will not be activated (in an inactive state). When the user pulls out the user-login-identification means of the administration/drive module, the user-login-identification means of the administration/drive module will be closed; an function of modifying the PIN code is provided for the user as wel as the function for setting up the submit mode content input and record mode of the administration/drive module by the user, and the function for leading in and leading out the information stored in the user-login-identification means of the administration/drive module in the case of simple encryption.

The encrypted authentication file comprising the authorization information is provided to the ICP by the login verification serving party.

The interface module can provide to the ICP an interface for reading out or writing to the user-login-identification means of the administration/drive module; transmit the authentication file of the ICP to the login verification serving party for verification; and read from/write to the administration/drive module via API.

The server terminal verifies the ID of the ICP, and informs the result to the OCX.

The invention comprises the following steps:

1. The login verification serving party distributes the authentication file to the ICP for verifying the ICP ID.

2. The login verification serving party provides to the ICP a standard code sample which accesses the user-login-identification means of the administration/drive module via the Interface of the OCX. The ICP adds the storage and read code of the required data in the web page according to the code sample, and adds the link of OCX in the web page.

3. The user-login-identification means is provided with an original PIN code.

4. The user accesses the ICP website and automatically downloads the software of the user's administration/drive module and the OCX (which can also be downloaded from the website of the login verification serving party). The user is asked whether the software of the administration/drive module should be installed, and if yes, the installation is performed. A corresponding Tray Icon will be added on the user's desktop after the installation.

5. The user can activate the administration/drive module, close the administration/drive module, modify the PIN code, and lead in/out the information stored in the administration/drive module by using the administration/drive module software in the case that the user-login-identification means of the administration/drive module is connected.

6. The user accesses the ICP website, and the ICP reads the user-login-identification means of the administration/drive module via the Interface of the OCX. If the administration/drive module is in the active state, the OCX will transmit the ICP authentication file to the server terminal of the login verification serving party for verification. If the ICP is authorized, the server terminal will inform the OCX that the access to the user-login-identification means is permitted.

7. If required information is read out, the OCX will return the content to the ICP web page code and determine whether an automatic submit and login should be performed according to the user's setup. If the required information is not read out (user has not logged in), the OCX will inform the ICP web page code that required information is not read out.

8. The ICP stores data in the user's user-login-identification means of the administration/drive module via the interface of the OCX when the user logs in the ICP website by using a set of registration information for the first time or selects to log in once more(user manually enters the registration information). If the administration/drive module is in the active state, the OCX will transmit the ICP authentication file to the server terminal of the login verification serving party for verification. If the ICP is authorized, the server terminal will inform the OCX that the access to the user-login-identification means is permitted. The OCX will store the data in the user-login-identification means of the administration/drive module.

If a user has several sets of registration information in the same registration web page, to save these registration information simultaneously or only to save the last set is determined by the interface parameters added in the web page by the ICP invoking the OCX.

### Particular Embodiments

User: Mr. Wang; ICP: sina, 263; Mr. Wang's personal information is that he has two usernames in the sina, wherein the username 1 is dingding and the password is ding2002, and the username 2 is joy and the password is 991817; and he has two e-mail addresses in the 263, wherein the e-mail address 1 is xiaowang@263.net and the password is 991817, the e-mail address 2 is xiaowang111@263.net and the password is 991817. The user-login-identification means of the administration/drive module has an initial password of 12345678.

The login verification serving party distributes the authentication files to the sina and the 263(the two authentication files are different). At the same time the login verification serving party provides to the sina and the 263 the standard code sample which accesses the user-login-identification means of the administration/drive module via the Interface of the OCX.

The sina provides the automatic downloads (linking to the website of the login verification serving party) of the OCX and the user's administration/drive module software in its own website. The sina adds the relating code in the member login web page of its own website, and when the user opens the web page, the sina will read the information in the user-login-identification means of the administration/drive module via the OCX. When the user logs in manually, the sina stores the information (including form number and user's information) in the user-login-identification means of the administration/drive module via the OCX. The sina has set that the old information will be overlapped by the new information in the case that there is the information with the same form number and there is not multi-registration information link window.

The 263 provides the automatic downloads (linking to the website of the login verification serving party) of the OCX and the user's administration/drive module software in its own website. The 263 adds the relating code in the member login web page of its own website, and when the user opens the web page, the 263 will read the information in the user-login-identification means of the administration/drive module via the OCX. When the user logs in manually, the 263 stores the information (including form number and user's information) in the user-login-identification means of the administration/drive module via the OCX. Since there is multi-registration information link window in the 263, the 263 sets that the new information will be stored as a new one in the case that there is the information with the same form number in the 263.

Mr. Wang accesses www.sina.com.cn, and downloads the administration/drive module software and the OCX automatically. When the download completes, a dialogue window of “whether the administration/drive module software should be installed” is displayed. Mr. Wang selects yes and installs the administration/drive module software. When the installation completes, a Tray Icon named “the administration/drive module software” is added on the desktop. Mr. Wang inserts the user-login-identification means of the administration/drive module, and the administration/drive module software prompts “enter the password:”, then Mr. Wang enters “12345678” and selects yes, so that administration/drive module is activated. The Tray Icon is shown as in the active state. Mr. Wang clicks the Tray Icon of “the administration/drive module”, and selects “modify the password”, and then enters the password of 12345678; and enters the new password of wang1817; and confirms the new password of wang1817. After the confirmation, the password is modified into wang1817, and the Tray Icon is still shown as in the active state.

Mr. Wang selects user-login on the sina home page. The relating code added in the member login web page by the sina tries to read Mr. Wang's user-login-identification means of the administration/drive module via the interface of the OCX (which introduces the parameters such as form number). The OCX accesses the user-login-identification means of the administration/drive module, and confirms that it is in the active state. The OCX obtains the sina's authentication file and transmits it to the administration/drive module. The administration/drive module looks up the relating information in Mr. Wang's user-login-identification means of the administration/drive module according to the authentication file and the form number, and if no required information is found, the OCX will informs the sina that the page code does not obtain the required information. Mr. Wang enters the login information in which the username is dingding and the password is ding2002, and then logs in. The relating code added in the member login web page by the sina tries to store the data in Mr. Wang's user-login-identification means of the administration/drive module via the interface of the OCX (which introduces the parameters such as form number, user information, etc.). The OCX accesses the user-login-identification means of the administration/drive module and confirms that it is in the active state. The OCX obtains the authentication file of the sina and transmits the file to the administration/drive module. The administration/drive module looks up the relating information in Mr. Wang's user-login-identification means of the administration/drive module according to the authentication file and the form number, and the OCX stores the data in Mr. Wang's user-login-identification means of the administration/drive module in the case that no identical form number is found. Mr. Wang closes the sina and enters the home page of the sina again, and it is detected that the administration/drive module software and the OCX have already been downloaded, and the automatic download of the administration/drive module software and the OCX is not needed. Mr. Wang selects the user-login. The relating code added in the member login web page by the sina tries to read Mr. Wang's user-login-identification means of the administration/drive module via the interface of the OCX (which introduces the parameters such as form number, etc.). The OCX accesses the user-login-identification means of the administration/drive module and confirms that it is in the active state. The OCX obtains the authentication file of the sina and transmits the file to the administration/drive module. The administration/drive module looks up the relating information in Mr. Wang's user-login-identification means of the administration/drive module according to the authentication file and the form number, and the OCX transmits the information to the sina web page code in the case that the required information is found. The sina web page code obtains the information and then automatically logs in by using the username of dingding and the password of ding2002. Mr. Wang selects to log in once more and enters the login information in which the username is joy and the password is 991817, and then logs in. The relating code added in the member login web page by the sina tries to store the data in Mr. Wang's user-login-identification means of the administration/drive module via the interface of the OCX (which introduces the parameters such as form number, user information, etc.). The OCX accesses the user-login-identification means of the administration/drive module and confirms that it is in the active state. The OCX obtains the authentication file of the sina and transmits the file to the administration/drive module. The administration/drive module looks up the relating information in Mr. Wang's user-login-identification means of the administration/drive module according to the authentication file and the form number, and the OCX stores the new data in Mr. Wang's user-login-identification means of the administration/drive module to overlap the old data in the case that the same form number is found. Mr. Wang clicks the Tray Icon of the “administration/drive module” and selects “close the administration/drive module”, and then the Tray Icon is shown as in the inactive state.

Mr. Wang accesses www.263.net. It is detected that the administration/drive module software and the OCX have already been downloaded, and the automatic download of the administration/drive module software and the OCX is not needed. The mail-login relating code added in the home page by the 263 tries to read Mr. Wang's user-login-identification means of the administration/drive module via the interface of the OCX (which introduces the parameters such as form number). The OCX accesses the user-login-identification means of the administration/drive module and finds that it is in the inactive state. The OCX informs the 263 that the page code does not obtain the required information. Mr. Wang clicks the Tray Icon of the “administration/drive module” and selects the “activate the administration/drive module”, and then the Tray Icon is shown as in the active state. Mr. Wang enters the mail-login information, in which the username is xiaowang@263.net and the password is 991817, and then logs in. The mail-login related code added in the home page by the 263 tries to store the data in Mr. Wang's user-login-identification means of the administration/drive module via the interface of the OCX (which introduces the parameters such as form number, user information, etc.). The OCX accesses the user-login-identification means of the administration/drive module and finds that it is in the active state. The OCX obtains the authentication file of the 263 and transmits the file to the administration/drive module. The administration/drive module looks up the relating information in Mr. Wang's user-login-identification means of the administration/drive module according to the authentication file and the form number, and the OCX stores the data in Mr. Wang's user-login-identification means of the administration/drive module in the case that no identical form number is found. Mr. Wang selects to log in once more and enters the login information in which the username is xiaowang111@263.net and the password is 991817, and then logs in. The mail-login relating code added in the home page by the 263 tries to store the data in Mr. Wang's user-login-identification means of the administration/drive module via the interface of the OCX (which introduces the parameters such as form number, user information, etc.). The OCX accesses the user-login-identification means of the administration/drive module and confirms that it is in the active state. The OCX obtains the authentication file of the 263 and transmits the file to the administration/drive module. The administration/drive module looks up the relating information in Mr. Wang's user-login-identification means of the administration/drive module according to the authentication file and the form number, and the OCX stores the new data in Mr. Wang's user-login-identification means of the administration/drive module without changing the old data in the case that the same form number is found. Mr. Wang closes the 263 and enters the home page of the 263 again, and it is detected that the administration/drive module software and the OCX have already been downloaded, and the automatic download of the administration/drive module software and the OCX is not needed. Mr. Wang selects the user-login. The mail-login relating code added in the home page by the 263 tries to read Mr. Wang's user-login-identification means of the administration/drive module via the interface of the OCX (which introduces the parameters such as form number, etc.). The OCX accesses the user-login-identification means of the administration/drive module and confirms that it is in the active state. The OCX obtains the authentication file of the 263 and transmits the file to the administration/drive module. The administration/drive module looks up the relating information in Mr. Wang's user-login-identification means of the administration/drive module according to the authentication file and the form number, and the OCX transmits the information to the 263 web page code in the case that two pieces of required information are found. The 263 web page code obtains the information, and then displays two usernames of xiaowang@263.net and xiaowang111@263.net in the pulldown box of the username item. Mr. Wang clicks xiaowang@263.net and automatically logs in by using the username of xiaowang@263.net and the password of 991817. Mr. Wang pulls out the user-login-identification means of the administration/drive module, and the administration/drive module software closes the administration/drive module. The Tray Icon is shown as in the inactive state.

The authentication file is an encryption file. The authentication file can include the primary information such as valid time, valid data segment, etc. wherein the valid time defines the period of validity of the authentication file. If the authentication file exceeds the valid date, it is invalid, and then the login verification serving party has to distribute the authentication file to the ICP again. The valid data segment defines the valid data segment which can be accessed by the ICP in the user-login-identification means. The authentication file is transmitted to the administration/drive module by the OCX and decrypted by the administration/drive module. The procedure can also be performed by the following method:

The login verification serving party distributes the authentication file to the ICP, and the OCX transmits the authentication file to the login verification serving party in the case that the ICP tries to access the user-login-identification means, and then the login verification serving party transmits the verification result back to the OCX. In this case, the authentication file distributed to the ICP can only comprise simple index and verification information, but the login verification serving party has to maintain a whole database of authentication files in order to provide more renewal information.

It is to be understood that the preferred embodiments intend only to explain but not to limit the present invention. Although the present invention has been described in detail by referring to the above-mentioned embodiments, it should be appreciated that any modifications or equivalents of the invention are not departing from the principle of the present invention.

What is claimed is:

1. A method for centralizing administration of user registration information across networks, characterized by: including at least an Internet Content Provider (ICP) and a user-login-identification means which can access an online terminal; wherein the ICP adds an interface module in a login web page and accesses the user-login-identification means via the interface module, and the ICP also provides an administration/drive module monitoring access of the user-login-identification means to set up a connection and hang up the connection for the user-login-identification means in the login web page; the user-login-identification means is provided with an ID number, and user's login identification information is stored in the user-login-identification means; ICP access authentication information is stored in the user-login-identification means to verify whether the accessing ICP is authorized to access; if the accessing ICP passed the verification, its access is permitted, otherwise the access is not permitted; wherein the ICP is permitted to access the user-login-identification means only if it is authenticated, when the user-login-identification means is activated; authenticating comprises, obtaining an authentication file via the interface module, transmitting the authentication file to the administration/drive module, decrypting the authentication file by the administration/drive module, and accessing the user-login-identification means.

2. The method of claim 1, wherein the administration/drive module can also lead in and/or lead out data stored in the user-login-identification means so as to backup the data; the administration/drive module can also automatically log in, in the case that the ICP accesses the user-login-identification means via the interface module and verifies the identification information.

3. The method of claim 1, wherein the ICP accessing the user-login-identification means includes checking the user ID identification information stored in the user-login-identification means, or generating the user ID identification information in the user-login-identification means.

4. The method of claim 3, wherein the ICP reads the information stored in the user-login-identification means, and if login identification information is obtained, the interface module returns the login identification information to the ICP web page and determines whether a login-submit or an automatic submit & login should be performed according to user's setup; if the login identification information is not obtained, the interface module informs the web page that the login identification information is not available and stores the generated login identification information in the user-login-identification means.

5. The method of claim 4, wherein an ICP web page is provided with a registration information window; the ICP invokes parameters of the interface module and simultaneously saves several sets of registration information of a same web page or saves the last set of registration information in the user-login-identification means, and the registration information can also be displayed on the ICP web page.

6. The method of claim 5, wherein the an ICP web page is provided with a registration information window; the ICP accesses the user-login-identification means via the interface module and verifies the login identification information provided by the ICP web page, and stores new login identification information in the user-login-identification means to overwrite original login identification information, and transfers relating information to the ICP web page; the information is displayed on the web page after being obtained.

7. The method of claim 5, wherein the ICP web page is provided with a plurality of window links of the registration information; the ICP reads the user-login-identification information stored in the user-login-identification means and verifies the login identification information provided by the ICP web page; if verification appears negative, the login identification information is stored in the user-login-identification means, and if positive, the login identification information is directly read out and the relating information is transferred to the ICP web page; the information is displayed on the web page after being obtained.

8. The method of claim 1, further includes a login verification serving party for implementing prior authentication to the ICP and obtaining guide information of the user-login-identification means.

9. The method of claim 1, wherein the ICP is connected with a login verification serving party which transmits a code for accessing the user-login-identification means to the ICP, and the ICP adds the login identification information in the login web page according to the code, and the interface module transmits the ICP information to the login verification serving party for verification; if the ICP information passed the verification, the ICP is permitted to access the user-login-identification means, wherein the user activates the user-login-identification means by using a password, and then the ICP accesses the login verification serving party for an authentication via the interface module; if the authentication is valid, the ICP can operate the user-login-identification means via the interface module and the actuating password used by the user is provided by the login verification serving party or preset in the means; the encryption files of the ICPs transmitted by the login verification serving party are different from each other.

10. A system for realizing the method for centralizing administration of user registration information across networks, characterized by, comprising a computer, Internet networks, an ICP and a user-login-identification means, wherein the computer can log in the Internet networks to communicate with different ICPs; the user-login-identification means is capable of accessing the computer from outside and has at least an identification number and encryption storage space; the user-login-identification means performs the information transmission by operating the computer.

11. The system of claim 10, wherein the ICP is connected with a login verification serving party which transmits a code for accessing the user-login-identification means to the ICP, and the ICP adds the login identification information in the login web page according to the code, and the interface module transmits the ICP information to the login verification serving party for verification; if the verification is valid, the ICP is permitted to access the user-login-identification means, and the login verification serving party is a server.

12. The system of claim 10, wherein information transmission between the computer and the user-login-identification means should be processed with encryption or decryption; the encryption includes protecting an encryption area by using the user's PIN code or utilizing RSA 512PKI key management encryption method.

13. The system of claim 12, wherein the user-login-identification means is also provided with a storage region for storing the information of the ICP itself.

14. The system of claim 13, wherein the user-login-identification means is an external and portable memory means with a standard data interface, or a card-reader means or an ID identifying means therof.

15. The system of claim 14, wherein the user-login-identification means can be a USB storage device, a CF card, a MMC card, a SD card, a SMC card, an IBM Micro Drive card, a flash storage module or and IC card.

16. The system of claim 14, wherein the portable memory card-reader means can be a CF card processor, a MMC card processor, a SD card processor, a SMC card processor, an IBM Micro Drive card processor or an IC card processor.

17. The system of claim 13, wherein the user-login-identification means is a computer peripheral, such as a keyboard, a mouse, a handwriting board or sound boxes.

18. The system of claim 13, wherein the user-login-identification means is a portable PDA, a music player or an electrical dictionary.
